(19) United States
(12) Patent Application Publication
(10) Pub. No.: US 2025/0296269 A1
(43) Pub. Date: Sep. 25, 2025

(54) METHOD FOR MANUFACTURING A MOLDED DECORATIVE PART, MOLDED DECORATIVE PART AND LOADING STATION FOR A MOTOR VEHICLE COMPRISING SUCH A MOLDED DECORATIVE PART

(71) Applicant: JOYSONQUIN Automotive Systems GmbH, Rutesheim (DE)

(72) Inventor: Philip FRUCHT, Rutesheim (DE)

(21) Appl. No.: 19/083,727

(22) Filed: Mar. 19, 2025

(30) Foreign Application Priority Data
Mar. 21, 2024 (DE) 102024108136.8

(51) Int. Cl. B29C 45/14; B29L 31/30; B60R 13/02

(52) U.S. Cl. CPC B29C 45/14811; B60R 13/02; B29L 2031/302

(57) ABSTRACT

A method for manufacturing a molded decorative part for a motor vehicle, in particular a cover for a charging station for a mobile radio device, in which a decorative layer having at least one perforation extending from a rear side of the decorative layer to a visible surface of the decorative layer and having a soft-elastic plastic layer on the rear side is inserted into a mold, in which the rear side of the decorative layer is back-injected with a carrier plastic material forming a carrier in such a way that a projection is formed by the soft-elastic plastic layer, which projection projects beyond the visible-side surface on the visible side and is supported in a shaping manner by the solidified carrier plastic material.

### FIELD OF THE INVENTION

The present invention relates to a method for manufacturing a motor vehicle.

### BACKGROUND OF THE INVENTION

Molded decorative parts of this kind are usually used for the interior trim of motor vehicles. A method is commonly used in which a decorative layer is back-injected with a plastic that serves as a carrier for fastening the molded decorative part in the motor vehicle. The decorative layer can be coated on the visible side with a paint, for example by overmolding the visible side in a two-component injection molding process with the decorative layer as an insert in the injection mold.

### SUMMARY OF THE INVENTION

The underlying problem of the present invention is to provide a method for manufacturing a molded decorative part that is particularly suitable for covering a charging station for a mobile phone in a motor vehicle. Furthermore, the present invention aims to provide a corresponding molded decorative part. The present invention also provides a charging station for a motor vehicle that is intended for inductive charging of a terminal device. In the method according to the invention, a cover for the charging station is produced by first providing a decorative layer with at least one opening. The decorative layer has a rear side, which is provided for attachment to a carrier, and a visible side, which characterizes or defines the decorative appearance within the vehicle. The visible side surface of the decorative layer can be formed by any decorative design, such as veneer, leather, plastic, in particular with a carbon look, metal or the like. The decorative layer usually has a substantially flat, two-dimensional extent. The decorative layer is usually relatively thin.

A perforation extends from the back of the decorative layer to the visible-side surface. A soft-elastic plastic layer is provided on the back of the decorative layer. An adhesive agent and/or a fleece can be provided between this plastic layer and the decorative layer. These further layers serve in particular to connect the soft-elastic plastic layer to the decorative layer. If further layers are provided between the decorative layer and the soft-elastic plastic layer, these are also usually penetrated by the perforation.

According to the present invention, however, the soft-elastic plastic layer is not only located on the back of the decorative layer. It extends through the decorative layer and protrudes beyond the visible-side surface of the decorative layer in the area of at least one perforation. The soft-elastic plastic layer forms a protrusion that prevents an object placed on the cover from slipping. The soft-elastic plastic layer can be formed from a TPE, polyester or TPU. As usual, the molded decorative part has a carrier that is formed by solidified carrier plastic material. In the present invention, this carrier plastic material is injected behind the decorative layer. It is understood that at least the soft-elastic plastic layer is located between the carrier plastic material and the decorative layer. The solidified carrier plastic material provides shape support for the projection that extends beyond the visible-side surface on the visible side and is formed by the soft-elastic plastic that passes through the perforation. This means that the solidified carrier plastic material and the plastic material of the soft-elastic plastic layer are regularly located in the perforation and at least a partial area of the soft-elastic plastic layer projects beyond the visible-side surface, possibly also a part of the solidified carrier plastic material.

During the molding process within the mold, which is usually an injection mold, a mold part is placed against the visible side of the decorative layer, which forms a cavity in the area of the opening, which is dimensioned in such a way that it allows the soft-elastic plastic layer to bulge out over the visible-side surface of the decorative layer. The shape of this cavity determines the cross-sectional shape of the protrusion. The protrusion usually has a convex surface or end face, which is usually flush with the visible-side surface of the decorative layer at the edge of the perforation. Insofar as the present invention is based on the visible-side surface of the decorative layer, this can also be formed by a paint finish or another application on a substrate that essentially forms the decorative layer. For example, a veneer can be provided with a coat of paint that maintains the color fastness of the wood grain over the lifetime of the molded decorative part. The protrusion can be formed by the soft-elastic plastic layer being forced out over the visible-side surface by the injection pressure acting during back-injection.

Alternatively or in addition, the soft-elastic plastic layer can be deformed in the direction of the visible-side surface by a forming die before being inserted into the mold or within the mold. Such a preforming step of the soft-elastic plastic layer is particularly desirable when a large number of perforations are provided close together, which may lead to the need for the soft-elastic plastic layer to be deformed at different points. The soft-elastic plastic layer may have an insufficient ability to follow the deformation beyond the visible-side surface. For these reasons, the soft-elastic plastic layer can already be brought into its final, protruding form, or at least partially reformed in the direction of this form, by forming, in particular plastic deformation, before back-injection with the carrier plastic material, so that the subsequent injection molding with the carrier plastic material only has to effect a certain portion of the total deformation of the soft-elastic plastic layer.

The usual methods can be used to produce the opening, such as punching, cutting or laser cutting. This processing of the decorative layer is usually carried out on a veneer at least after the color has been applied. Only then is the soft-elastic plastic layer laminated on, and then the intermediate product produced in this way is shaped into a three-dimensional preform, which is then placed in the mold to form the carrier. After that, it may be necessary to mill the back-injected intermediate product. If the selected decorative layer makes it necessary or desirable for design reasons, the visible-side surface of the decorative layer can then be painted.

The decorative layer can be prepared with a pattern of perforations. This pattern can be a regular pattern of perforations, which can be designed, for example, as a symbol or as ribs or waves. The perforations can be designed as a logo that corresponds to a signet or brand of the vehicle manufacturer.

If the molded decorative part has several projections, these can each have an identical or different design, in particular cross-sectional shapes.

The final painting of the decorative layer should, if necessary, be done in particular with a paint that has good adhesion to the surface of the decorative layer but poor or no adhesion to the surface of the soft-elastic plastic material, so that the paint is not permanently on the projection and its haptic properties are determined by the material of the soft-elastic plastic.

The method according to the invention is also suitable for molded decorative parts other than covers for a charging station. For example, it is conceivable to use the protrusions to set haptic markers whose meaning can be felt. Within the scope of the present invention, it is conceivable to design the perforations in such a way that the protrusions result in information being reproduced in Braille.

The protrusions usually extend between 0.1 and 2.0 mm above the visible-side surface of the decorative layer.

The protrusions can also have a decorative effect. They can be opaque and/or colored in any color. In the case of a transparent or translucent soft-elastic plastic layer, the layer on the back of the soft-elastic plastic layer can be visible from the visible side behind the soft-elastic plastic layer and can contribute to the decorative appearance of the molded decorative part.

In view of the use of the decorative layer as a cover for a charging station for the inductive charging of a terminal device, the molded decorative part as a whole should have a thickness of only between 1.5 mm and 4.5 mm. Below the storage surface for the end device, which is formed by the molded decorative part of the present invention, there is an inductive charging device whose magnetic fields must pass through the molded decorative part and reach the end device, for which purpose the molded decorative part should not exceed the above-stated thickness.

The decorative molding indicated in accordance with a secondary aspect of the present invention has a decorative layer that is provided with at least one perforation extending from the visible-side surface of the decorative layer to a rear side opposite the latter. This perforation is interspersed with a soft-elastic plastic, which forms a coating on the back of the decorative layer and, opposite this, a projection that extends over the visible-side surface of the decorative layer, and is connected on the back to a carrier. As mentioned above, the carrier usually also passes through the plane containing the decorative layer and may extend beyond this on the visible side.

According to a preferred further development of the present invention, the molded decorative part is suitable for conveying optical information in the dark. For this purpose, the molded decorative part has a light source that interacts in a light-conducting manner with a light-conducting element or light-conducting segment provided on the surface of the cover. According to a specific embodiment of this basic proposal, the soft-elastic plastic is formed as a light guide. The soft-elastic plastic is therefore suitable for itself to guide light rays as a light conductor. The soft-elastic plastic can be, for example, a transparent, translucent or possibly colored TPE, polyester or TPU. In this design, the light-conducting soft-elastic plastic is usually located between two non-light-conducting layers, which, for example, act as an adhesion promoter to bond the soft-elastic plastic to the decorative layer on the one hand and to the carrier on the other. As mentioned above, this does not preclude the presence of further intermediate layers, which may also be opaque. This design ensures that the soft-elastic plastic is only perceived as a light element on the visible surface of the decorative layer. In addition to the projections, the soft-elastic plastic can also form surface portions on the surface of the cover or be visible as surface elements that are recessed or flush with the visible-side surface of the decorative layer. In the first case, the molding tool can have a molding tool part that provides a cavity for the projection and a lens contour for the light-conducting segment, which engages in a light-conducting opening that is recessed in the decorative layer. When the soft-elastic plastic is molded, for example, it is forced into the light guide opening and shaped by the lens contour in a predetermined manner. The lens contour can take on any shape.

In the second case, it is sufficient for the molded part to form only a counter surface that continues the contact surface for the decorative layer, against which the soft-elastic plastic material is molded to form a light guide flush with the visible-side surface of the decorative layer.

According to a preferred embodiment of the present invention, the molded decorative part preferably has a ventilation opening that passes through the molded decorative part. This further development is guided by the idea that, in the case of a charging station in a motor vehicle for the inductive charging of a terminal device, not only a charging device is located below this storage surface, but also a blower, which cools the charging device and/or the terminal device lying on the storage surface. It is understood that several such charging openings can be provided, which are preferably arranged so that the cooling air stream covers the terminal to be heated over as large an area as possible.

Preferably, the ventilation opening is located at the transition between the projection and the decorative layer. The ventilation opening can follow the contour of the phase boundary between the projection and the decorative layer. The ventilation opening can extend over the entire edge of the protrusion, or on both sides of it, which is particularly advantageous if the decorative layer is provided with a layer of lacquer afterwards and after the protrusion has formed. This layer of lacquer comes to a predetermined end at the ventilation opening on the visible side.

The ventilation opening can be formed completely after the back-injection of the carrier and removal of the intermediate product produced thereby. However, the ventilation opening can also be formed in individual layers of the molded decorative part before and in others after or during the back-injection of the carrier.

Further details and advantages of the present invention will become apparent from the following description of an embodiment in conjunction with the drawing.

### BRIEF DESCRIPTION OF THE DRAWINGS

FIG. 1 is a schematic representation of an embodiment of a charging station.

FIG. 2 is a schematic cross-sectional view of an embodiment of a decor molding using the example of a storage surface for a terminal.

FIG. 3 is a schematic sectional view of a mold.

### DETAILED DESCRIPTION OF THE PREFERRED EMBODIMENTS

In the drawing, reference sign 2 denotes a charging station in a motor vehicle for the inductive charging of a terminal or end device 4, which is drawn on a storage surface 6 and above an inductive charging device 8. Reference sign 10 characterizes a blower, which is also located below the storage surface 6 in such a way that the air generated by the blower 10 cools the inductive charging device.

The storage surface 6 is formed by a molded decorative part 12 which is provided with ventilation openings 14, through which the air flow L generated by the blower 10 reaches the terminal or end device 4 and can cool it.

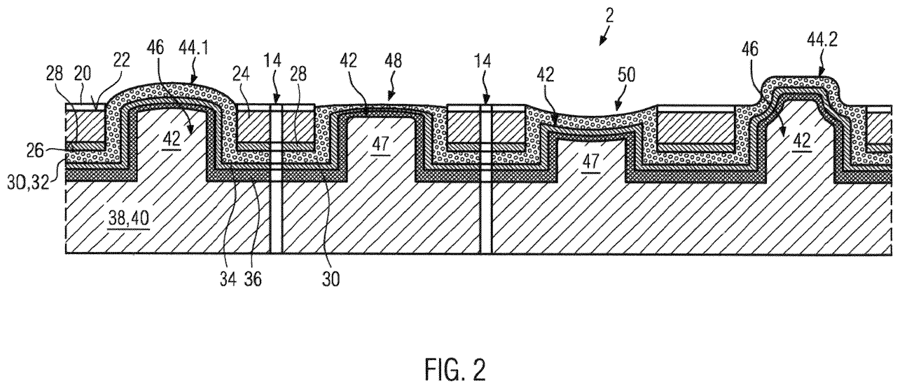

Reference 16 denotes a light source that interacts with a light guide 18, which will be explained in more detail below, as it is part of the molded decorative part 12. As the enlarged view in FIG. 2 shows, the molded decorative part 12 comprises several layers that extend essentially parallel to one another. From the outside in, these layers are a layer of lacquer 20 that is arranged on a visible-side surface 22 of a decorative layer 24. Reference sign 26 denotes a rear side of the decorative layer 24, which is provided with a thermoplastic bonding agent 28 that bonds a soft-elastic plastic layer 30 made of a soft-elastic plastic 32 to the decorative layer 24.

On the rear side 26 of the soft-elastic plastic layer 30, facing away from the decorative layer 24, there is a further thermoplastic bonding agent 34, which connects the soft-elastic plastic layer 30 to a fleece 36. A carrier 38 is connected to this fleece 36, which consists of a carrier plastic material 40, which is mainly a thermoplastic hard component.

The carrier 38 is shown schematically in the present case. On its rear side 26 facing away from the decorative layer 24, it can have fastening means for connecting the molded decorative part 12 to parts of a motor vehicle, such as, for example, latching lugs or other designs which form complementary mold surfaces for connection to the chassis of the vehicle.

In FIG. 2, reference sign 42 denotes an aperture, perforation, or opening 42 into which the carrier plastic material 40 and the layers normally provided between the decorative layer 24 and the carrier 38 are introduced. The soft, elastic plastic 32 forms a projection 44.1, 44.2, which is held in shape by a plug 46 of the carrier plastic material 40 that projects into the opening. In the example shown, the projection 44.1 extends above the visible-side surface 22 of the decorative layer 24. The same applies to the front area of the plug 46.

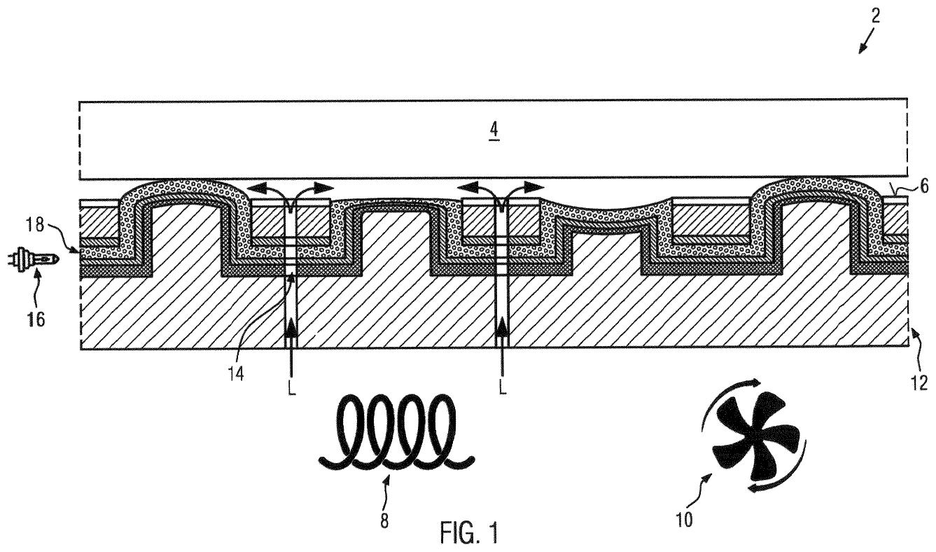

As FIG. 1 illustrates, the terminal 4 rests on the projections 44.1. These are formed from the soft elastic plastic 32 so that the terminal 4 is secured against slipping. In the example shown, the soft elastic plastic 32 has light-conducting properties and is coupled to the light source 16 as the light conductor 18. Reference sign 47 characterizes light-conducting openings, in which the soft-elastic plastic 32 is formed into a flush or concave light-conducting element 48, 50 and thus into an element that is set back with respect to the visible-side surface 22. The soft plastic 32 located in the light-conducting or light guide openings 47 does not act as a non-slip covering, but only as a light-conducting design element.

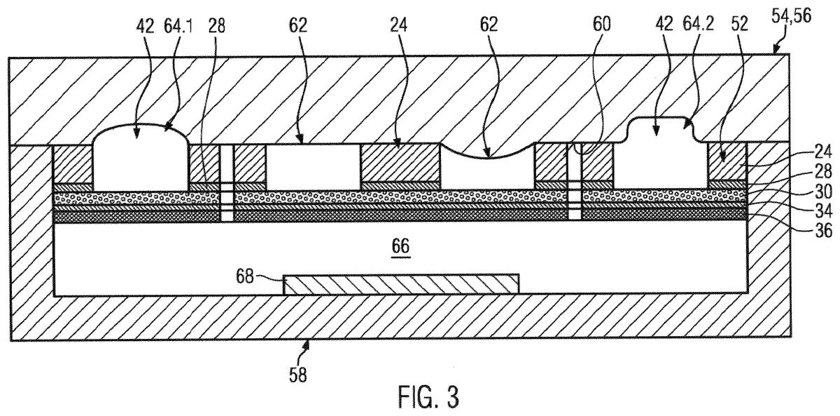

FIG. 3 illustrates an intermediate step in the production of the molded decorative part 12, in which a preform 52 is placed in a mold 54 comprising a first upper mold part 56 and a second, lower mold part 58. The preform 52 is in contact with a surface of the upper mold part 56. This upper mold part 56 forms a flat contact surface 60 against which the substantially flat visible-side surface 22 of the preform 52, which is formed by the decorative layer 24, bears. A lens contour 62 of the upper mold part 56 projects from this flat contact surface 60 and engages in the light guide opening 47. Reference sign 64.1, 64.2 denotes a cavity which is formed by the upper mold part 56 opposite the opening 42 and whose contour corresponds to the surface geometry of the projection 44.1, 44.2.

FIG. 2 shows examples of projections 44.1, 44.2 with different cross-sectional geometries. The left-hand projection 44.1 has a strictly convex cross-sectional shape. The left projection 44.1 completely overlaps the lacquer layer 20. The right projection 44.2 rises from an annular surface area of the soft-elastic plastic layer 30, which is formed flush with the lacquer layer 20, and is formed to be flat on its end face. Correspondingly, the mold part 56 has correspondingly designed cavities 64.1 and 64.2.

The preform 52 shown in FIG. 3 is produced by first selecting a veneer as the decorative layer 24 and applying a color layer to it. After that, the perforations or aperture 42, the light guide openings 47 and the ventilation openings 14 were cut out by laser. The decorative layer 24 is laminated by the soft-elastic plastic layer 30, incorporating the thermoplastic adhesive 28 on one side and the other adhesive or thermoplastic bonding agent 34 with the fleece 36 on the other. The intermediate product thus produced is then formed into the preform 52. The other layers 28, 30, 34, 36 are also perforated at the level of the ventilation openings 14.

After closing the two mold parts 56, 58, a carrier cavity 66 is formed on the back side 26 of the fleece layer 36 facing away from the decorative layer 24, into which the molten carrier plastic material 40 is injected. The acting injection pressure forces the soft-elastic plastic layer 30 in the direction of the contact surface 60, so that one concave lens contour 62 forms the concave light-guiding element in the light-guiding or light conducting opening 47 and the projection 44.1, 44.2 is formed in the cavity 64.1, 64.2, respectively. The flush configuration of light conducting element 48 is formed by contact against the other flush lens contour 62 when injection pressure forces the soft-elastic plastic layer 30 in the direction of flat contact surface 60. The carrier plastic material 40 solidifies and supports the soft, elastic plastic material 32 accordingly, shaping it.

Reference sign 68 denotes a tool projection 68 within the carrier cavity 66, by means of which an area of reduced wall thickness is formed on the molded decorative part 12, which can be penetrated in an improved manner by the magnetic waves for inductive charging.

The paint or lacquer layer 20 is then applied. This does not adhere to the soft-elastic plastic layer 30, so that any paint or lacquer 20 residues can be blown off where this paint or lacquer layer 20 is not intended to cover the visible-side surface 22 of the decorative layer 24. The present invention makes it possible to form a molded decorative part 12 with a low wall thickness so that an end device or terminal 4 resting on the storage surface 6 can be effectively charged inductively. The projections 44.1, 44.2 secure the end device or terminal 4 against slipping on the storage surface 6. The light-conducting or light guide openings 47 enable further optional decoration of the decorative molded part 12 and in particular optical designs that can also be recognized in the dark. The ventilation openings 14 prevent the end device or terminal 4 from overheating during inductive charging and effectively discharge cooling air that cools the inductive charging device.

### LIST OF REFERENCE DESIGNATIONS

2 charging station
4 end device
6 storage surface
8 inductive charging device
10 blower
12 molded decorative part
14 ventilation opening
16 light source
18 light guide
20 paint layer
22 visible-side surface
24 decorative layer
26 rear side
28 thermoplastic adhesion promoter
30 soft-elastic plastic layer
32 soft-elastic plastic
34 Adhesive agent
36 Fiber fleece
38 Carrier
40 Carrier plastic material
42 Opening
44 Protrusion
46 Plug
47 Light conductor opening
48 Flush light conductor element
50 Concave light conductor element
52 Preform
54 Mold
56 Upper Mold part
58 Lower Mold part
60 Contact surface
62 Lens contour
64 Cavity
66 Carrier cavity
68 Mold projection
L Airflow

What is claimed is:

1. A method for producing a decorative molded part for a motor vehicle, in particular a cover for a charging station for a mobile phone, in which a decorative layer is provided with at least one perforation extending from a rear side of the decorative layer to a visible-side surface of the decorative layer and, on the rear side, with a soft-elastic plastic layer, is inserted into a mold, in which the rear side of the decorative layer is back-injected with a carrier plastic material forming a carrier in such a way that a projection is formed by the soft-elastic plastic layer, which projection projects on the visible-side surface on the visible side and which is supported in a shaping manner by the solidified carrier plastic material.

2. The method according to claim 1, wherein the decorative layer is prepared as a veneer provided with a thermoplastic adhesive agent and is then provided with the at least one perforation.

3. The method according to claim 1, wherein the soft-elastic plastic layer is forced beyond the visible-side surface by the injection pressure acting during the back-injection molding.

4. The method according to claim 1, wherein the soft-elastic plastic layer is deformed by a forming die in the direction of the visible-side surface before being inserted into the mold.

5. The method according to claim 1, wherein the decorative layer is prepared with a pattern of perforations.

6. The method according to claim 1, wherein the decorative layer provided with the plastic layer is prepared with a thickness of between 0.2 and 0.4 mm.

7. A molded decorative part of a motor vehicle, in particular a cover for a charging station for a mobile radio device, having a decorative layer which is provided with at least one perforation extending from a visible-side surface of the decorative layer to a rear side located opposite the latter, which is penetrated by a soft-elastic plastic that forms a coating on the rear side of the decorative layer and, opposite thereto, a projection that extends over the visible-side surface of the decorative layer and is connected on the rear side to a carrier.

8. The molded decorative part according to claim 7, wherein the soft-elastic plastic forms a light guide which is connected to a light source.

9. The molded decorative part according to claim 7 further comprising at least one ventilation opening which passes through the molded decorative part.

10. A charging station for a motor vehicle for the inductive charging of a terminal having a storage surface for the terminal and an inductive charging device arranged under the storage surface, wherein the storage surface is formed by a molded decorative part according to claim 7.

11. The charging station according to claim 10, wherein the at least one projection forms a non-slip support for the terminal.

12. A motor vehicle interior trim decorative molded part comprising:
a decorative layer having a visible side surface, said decorative layer having projection openings and light conducting openings;
an elastic plastic layer positioned on a rear side of said decorative layer covering the projection openings and the light conducting openings;
a carrier formed on the rear side of said decorative layer, said carrier having plugs configured to position projection portions of said elastic plastic layer through the projection openings past the visible side surface of said decorative layer; and
ventilation openings extending through said decorative layer, said elastic plastic layer, and said carrier, whereby a device to be charged is capable of being placed on the projection portions.

13. The motor vehicle interior trim decorative molded part according to claim 12 wherein:
said elastic plastic layer comprises a light guide.

14. The motor vehicle interior trim decorative molded part according to claim 13 further comprising:
a light source coupled to the light guide;
a charging device positioned adjacent said carrier; and
a blower coupled to said ventilation openings.
